(19) United States
(12) Patent Application Publication
(10) Pub. No.: US 2015/0251877 A1
(43) Pub. Date: Sep. 10, 2015

(54) ELEVATOR APPARATUS

(71) Applicant: Takeshi NIIKAWA, Chiyoda-ku, Tokyo (JP)

(72) Inventor: Takeshi Niikawa, Chiyoda-ku (JP)

(73) Assignee: Mitsubishi Electric Corporation, Chiyoda-ku, Tokyo (JP)

(21) Appl. No.: 14/435,330

(22) PCT Filed: Dec. 17, 2012
(86) PCT No.: PCT/JP2012/082673

§ 371 Date: Apr. 13, 2015

(51) Int. Cl. B66B 5/04; B66B 5/16

(52) U.S. Cl. CPC B66B 5/04; B66B 5/16; B66B 5/046

(57) ABSTRACT

In an elevator apparatus, an acceleration detector that generates an acceleration signal that corresponds to acceleration in a direction of travel of a car is mounted to the car. A car velocity monitoring portion finds a traveling velocity of the car from the acceleration signal from the acceleration detector. An excessive velocity is preset in the car velocity monitoring portion. The car velocity monitoring portion stops the car by means of a braking apparatus to if the traveling velocity of the car reaches the preset excessive velocity.

### TECHNICAL FIELD

The present invention relates to an elevator apparatus in which a car is made to perform an emergency stop when there is an abnormality such as breakage of a suspending body or failure of a controlling apparatus, for example.

### BACKGROUND ART

In conventional elevator apparatuses, a speed governor rope that is wound around a speed governor sheave is linked to a car, and the speed governor sheave is rotated at a speed that corresponds to the traveling velocity of the car. If it is detected that the car has exceeded a rated velocity and reached a first overvelocity, due to an abnormality in the controlling apparatus, for example, power supply to a hoisting machine is interrupted to stop the car urgently. If the car is falling due to breakage of a suspending body, etc., a second overvelocity is detected by the speed governor, and a safety device is activated to make the car perform an emergency stop.

However, because the speed governor rope can only be disposed between a hoistway wall and the car, it is close to other equipment, and if swinging arises in the speed governor rope due to earthquakes, etc., there is a risk that the speed governor rope may interfere with the other equipment or get caught on it.

In answer to that, activating mechanisms have also been proposed that activate a safety device without using a speed governor rope. In these activating mechanisms, a reaction force generator that moves vertically using gravitational acceleration that accompanies dropping of a car is disposed on top of the car, and the reaction force generator is linked to wedges on the safety device by means of linking mechanisms (see Patent Literature 1, for example).

Methods have also been proposed that activate a safety device electrically based on car velocity that is detected by a car velocity sensor (see Patent Literature 2, for example).

### CITATION LIST

### Patent Literature

### [Patent Literature 1]

Japanese Patent Laid-Open No. 2004-345803 (Gazette)

### [Patent Literature 2]

International Publication No. (WO) 2004/083091

### SUMMARY OF THE INVENTION

### Problem to be Solved by the Invention

In conventional safety device activating mechanisms such as that in Patent Literature 1, because it is necessary to link the reaction force generator and the safety device directly by a linking mechanism, the position of installation of the activating mechanism is limited. Because it is necessary to determine configuration of the reaction force generator so as to allow for inertial mass of the linkage system and sliding loss in movable portions, etc., in reality it is also considerably difficult to configure. In addition, because the detection of overvelocity is not possible even if the safety device can be activated by abnormal acceleration detection, it is necessary to dispose an overvelocity detecting means separately in order to activate the safety device by overvelocity detection.

In Patent Literature 2, because a detailed configuration of the car velocity sensor is not disclosed, it is unclear what kind of configuration is more suitable as a sensor for activating the safety device.

The present invention aims to solve the above problems and an object of the present invention is to provide an elevator apparatus that can detect excessive velocity of a car using a simple configuration without using a speed governor rope, to stop the car appropriately when excessive velocity is detected.

### Means for Solving the Problem

In order to achieve the above object, according to one aspect of the present invention, there is provided an elevator apparatus including: a car; a braking apparatus that brakes traveling of the car; an acceleration detector that is mounted to the car, and that generates an acceleration signal that corresponds to acceleration in a direction of travel of the car; and a car velocity monitoring portion that finds a traveling velocity of the car from the acceleration signal, and that stops the car by means of the braking apparatus if the traveling velocity of the car reaches a preset excessive velocity.

### Effects of the Invention

In the elevator apparatus according to the present invention, because the acceleration detector that generates an acceleration signal that corresponds to acceleration in a direction of travel of the car is mounted to the car, and the car velocity monitoring portion finds the traveling velocity of the car from the acceleration signal, and the car is stopped by the braking apparatus if the traveling velocity of the car reaches the preset excessive velocity, excessive velocity of the car can be detected using a simple configuration without using a speed governor rope, enabling the car to be stopped appropriately when excessive velocity is detected.

### BRIEF DESCRIPTION OF THE DRAWINGS

FIG. 1 is a schematic configuration diagram that shows an elevator apparatus according to Embodiment 1 of the present invention partially in block form;

FIG. 2 is a schematic configuration diagram that shows an acceleration detector from FIG. 1;

FIG. 3 is a schematic configuration diagram that shows an acceleration detector according to Embodiment 2 of the present invention; and

FIG. 4 is a schematic configuration diagram that shows an elevator apparatus according to Embodiment 3 of the present invention partially in block form.

### DESCRIPTION OF EMBODIMENTS

Preferred embodiments of the present invention will now be explained with reference to the drawings.

### Embodiment 1

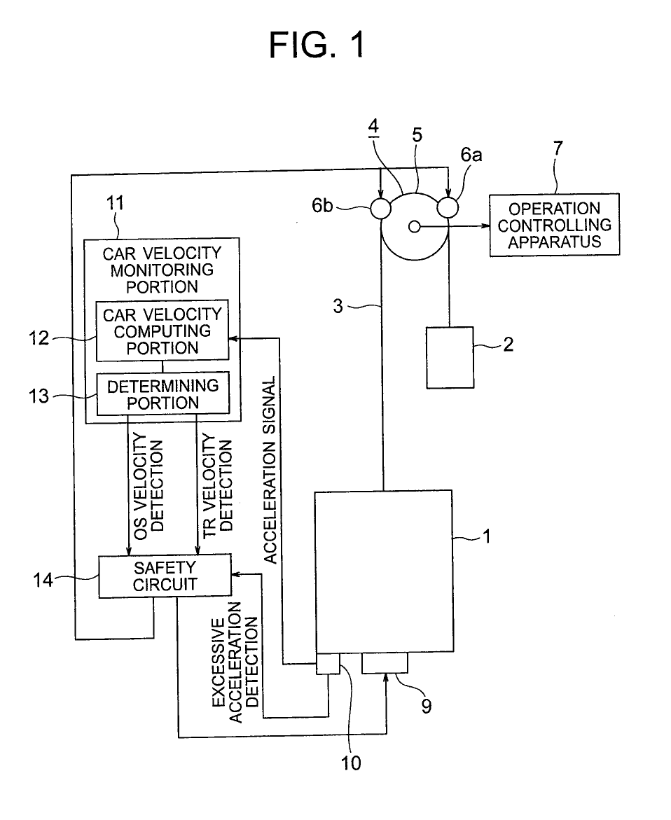

FIG. 1 is a schematic configuration diagram that shows an elevator apparatus according to Embodiment 1 of the present invention partially in block form. In the figure, a car 1 and a counterweight 2 are suspended inside a hoistway by a suspending body 3, and are raised and lowered by a hoisting machine 4, which is a driving apparatus. A pair of car guide rails (not shown) that guide raising and lowering of the car 1 and a pair of counterweight guide rails (not shown) that guide raising and lowering of the counterweight 2 are installed inside the hoistway.

The hoisting machine 4 has: a driving sheave 5; a hoisting machine motor (not shown) that rotates the driving sheave 5; and first and second hoisting machine brakes (electromagnetic brakes) 6a and 6b that brake rotation of the driving sheave 5. The suspending body 3 is wound onto the driving sheave 5. A plurality of ropes or a plurality of belts can be used as the suspending body 3.

The hoisting machine brakes 6a and 6b have: a brake wheel (a drum or a disk) that is coupled coaxially to the driving sheave 5; a brake shoe that is placed in contact with and separated from the brake wheel; a brake spring that presses the brake shoe against the brake wheel to apply a braking force; and an electromagnet that separates the brake shoe from the brake wheel in opposition to the brake spring to release the braking force.

Operation of the hoisting machine 4 is controlled by an operation controlling apparatus (an elevator controlling apparatus) 7. In other words, movement of the car 1 is controlled by the operation controlling apparatus 7. A hoisting machine encoder 8, which is a rotation detector that generates a signal that corresponds to rotation of the driving sheave 5, is disposed on the hoisting machine 4. The operation controlling apparatus 7 detects a traveling velocity of the car 1 based on the signal from the hoisting machine encoder 8.

A safety device 9 that makes the car 1 perform an emergency stop by gripping a car guide rail is mounted to the car 1. The safety device 9 is activated electrically by an actuator as disclosed in WO 2004/083091, for example.

The safety device 9 has, for example, an electromagnet that functions as an actuator, a braking spring, a braking segment (a wedge), and a guiding member. In a safety device 9 of this kind, the braking segment is held in a position that is separated from the car guide rail by the electromagnetic force of the electromagnet when the electromagnet is energized. When electric power supply to the electromagnet is shut off, the braking segment displaces along the guiding member due to a spring force from the braking spring, the braking segment is pressed against the car guide rail by a wedging effect, and the car 1 is braked by friction.

In Embodiment 1, a braking apparatus that brakes traveling of the car 1 includes the first and second hoisting machine brakes 6a and 6b and the safety device 9.

An acceleration detector 10 that generates an acceleration signal that corresponds to acceleration in the direction of travel of the car 1 is mounted to the car 1. The acceleration signal from the acceleration detector 10 is inputted into a car velocity monitoring portion (a control circuit board) 11. The car velocity monitoring portion 11 monitors the traveling velocity of the car 1 independently from the operation controlling apparatus 7.

The car velocity monitoring portion 11 has a car velocity computing portion 12 and a determining portion 13. The car velocity computing portion 12 finds the traveling velocity of the car 1 from the acceleration signal from the acceleration detector 10. Specifically, the car velocity computing portion 12 finds the traveling velocity of the car 1 by integrating the acceleration signal over time.

A first excessive velocity that is higher than a rated velocity, and a second excessive velocity that is higher than the first excessive velocity are preset in the determining portion 13. If the traveling velocity of the car 1 reaches the first excessive velocity, the determining portion 13 interrupts the electric power supply to the hoisting machine 4 (the hoisting machine motor and the electromagnets of the hoisting machine brakes 6a and 6b) using a safety circuit 14, to make the car 1 perform an emergency stop using the first and second hoisting machine brakes 6a and 6b.

If the traveling velocity of the car 1 reaches the second excessive velocity, the determining portion 13 interrupts the electric power supply to the hoisting machine 4 and the safety device 9 using the safety circuit 14, to make the car 1 perform an emergency stop using the safety device 9. The functions of the car velocity computing portion 12 and the determining portion 13 can be implemented by a microcomputer, for example.

In addition, if it is detected by the acceleration detector 10 that the acceleration of the car 1 has reached a preset excessive acceleration, then the electric power supply to the safety device 9 is interrupted by the safety circuit 14 without referral to the car velocity monitoring portion 11, and the car 1 is made to perform an emergency stop using the safety device 9.

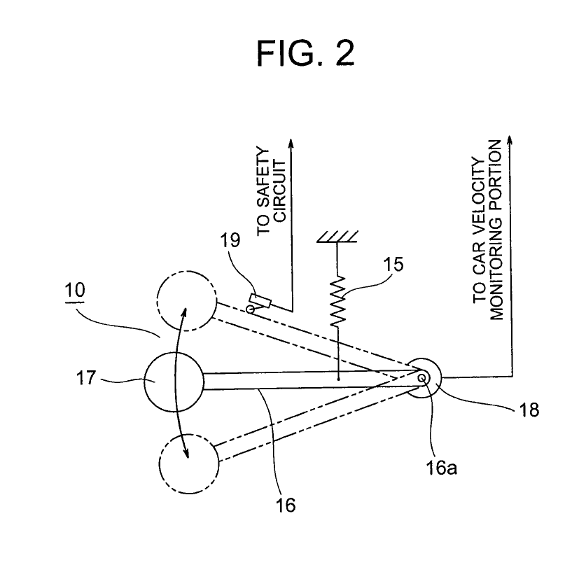

FIG. 2 is a schematic configuration diagram that shows the acceleration detector 10 from FIG. 1. The acceleration detector 10 has: a spring 15 that constitutes an elastic body; an arm 16 that constitutes a displacing member; a weight 17; an encoder 18 that constitutes a signal generating portion; and a descent safety switch 19.

The spring 15 is connected between the car 1 and the arm 16. A pivoting shaft 16a is disposed on a base end portion of the arm 16. The arm 16 is attached to the car 1 so as to be pivotable (swingable) around the pivoting shaft 16a. The weight 17 is fixed to the arm 16. The spring 15 is connected to the arm 16. Moreover, in FIG. 2, the weight 17 is fixed to a tip end portion of the arm 16, and the spring 15 is connected to an intermediate portion of the arm 16, but arrangement of the weight 17 and the spring 15 is not limited thereto.

The arm 16 elastically deforms the spring 15 while displacing (pivoting) in response to the acceleration of the car 1. In this example, the arm 16 is horizontal when the acceleration of the car 1 is zero, and displaces within a range such as that indicated by the double-dotted chain lines in FIG. 2 in response to the direction of travel and magnitude of the acceleration of the car 1.

The encoder 18 detects the pivoting of the arm 16, and generates a signal that corresponds to the amount of displacement (pivoting angle) of the arm 16 as an acceleration signal. The acceleration signal from the encoder 18 is inputted into the car velocity monitoring portion 11.

The descent safety switch 19 is actuated mechanically by the arm 16 if the amount of displacement of the arm 16 reaches a preset displacement threshold value when the car 1 is accelerating in a direction of descent or decelerating in a direction of ascent. In other words, the descent safety switch 19 is actuated if the acceleration in the direction of descent of the car 1 reaches the preset excessive acceleration. Thus, as described above, the electric power supply to the hoisting machine 4, the hoisting machine brakes 6a and 6b, and the safety device 9 is interrupted by the safety circuit 14 without referral to the car velocity monitoring portion 11.

In an elevator apparatus of this kind, because the acceleration detector 10 is mounted to the car 1, and the car velocity monitoring portion 11 finds the traveling velocity of the car 1 from the acceleration signal, and the car 1 is stopped by at least one of the safety device 9 and the hoisting machine brakes 6a and 6b if the traveling velocity of the car 1 reaches the preset excessive velocity, excessive velocity of the car 1 can be detected using a simple configuration without using a speed governor rope, enabling the car 1 to be stopped appropriately when excessive velocity is detected.

The risk that a speed governor rope may interfere with or get caught on other equipment due to earthquakes, etc., is thereby eliminated. Because equipment such as mechanical governors, tensioning sheaves, speed governor rope sway prevention, etc., can also be made obsolete, in addition to the speed governor rope, freedom of layout inside the hoistway and the machine room is improved. Reductions in cost and conservation of resources can also be achieved due to the reductions in equipment. In elevator apparatuses that have long hoisting zones, significant effects can be expected due to omitting the speed governor rope.

By implementing the integration of the acceleration signal electronically within the circuit board of the car velocity monitoring portion 11, conversion to the traveling velocity of the car 1 can be easily achieved. The first and second excessive velocities can be also be set freely, enabling comparison between the excessive velocities and the traveling velocity of the car 1 also to be implemented easily. Because of that, the present embodiment can be developed and applied easily to elevator apparatuses that have various specifications.

In addition, by making the acceleration detector 10 a spring-mass system such as that shown in FIG. 2, configuration can be simplified further, also facilitating setting of the excessive velocities. Because the acceleration, and in turn the traveling velocity, of the car 1 can be detected using a stable configuration that is robust against external disturbances, namely detecting the amount of rotational displacement of the arm 16, reliability is easily ensured.

Furthermore, because the car 1 is made to perform an emergency stop using the safety device 9 without referral to the car velocity monitoring portion 11 if the descent safety switch 19 is actuated, the safety device 9 can be activated more reliably and promptly if acceleration in the direction of descent of the car 1 becomes excessive due to breakage of the suspending body 3, for example, irrespective of the traveling velocity of the car 1 and the state of the car velocity monitoring portion 11. In other words, the safety device 9 can be activated at a lower speed than conventionally, without having to wait for the traveling velocity to reach the second excessive velocity.

### Embodiment 2

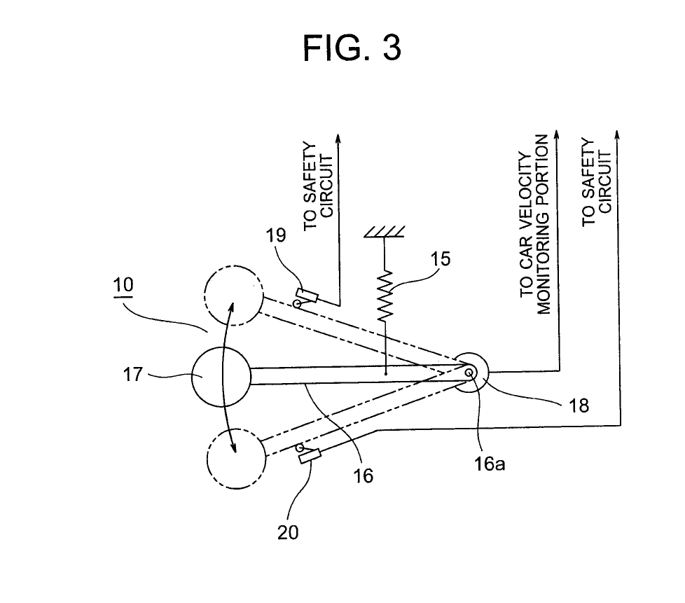

Next, FIG. 3 is a schematic configuration diagram that shows an acceleration detector according to Embodiment 2 of the present invention, overall configuration of the elevator apparatus being similar to that of Embodiment 1. In Embodiment 2, an ascent safety switch 20 is added to the acceleration detector 10 according to Embodiment 1.

The ascent safety switch 20 is actuated mechanically by the arm 16 if the amount of displacement of the arm 16 reaches a preset displacement threshold value when the car 1 is accelerating in a direction of ascent or decelerating in a direction of descent. In other words, the ascent safety switch 20 is actuated if the acceleration in the direction of ascent of the car 1 reaches a preset excessive acceleration for any reason (such as a runaway operation controlling apparatus 7, for example).

If the ascent safety switch 20 is actuated, then a braking apparatus that brakes traveling of the car 1 in the direction of ascent such as a rope brake (not shown) or the hoisting machine brakes 6a and 6b, for example, is activated by the safety circuit 14 without referral to the car velocity monitoring portion 11.

If a safety device 9 is used that can make the car 1 perform an emergency stop whether the direction of travel of the car 1 is upward or downward, as disclosed in WO 2008/155853, for example, the car 1 can also be made to perform an emergency stop using the safety device 9 when the ascent safety switch 20 is actuated.

If an acceleration detector of this kind is used, traveling of the car 1 can also be braked more reliably and promptly if acceleration in the direction of ascent of the car 1 becomes excessive, irrespective of the traveling velocity of the car 1 and the state of the car velocity monitoring portion 11.

### Embodiment 3

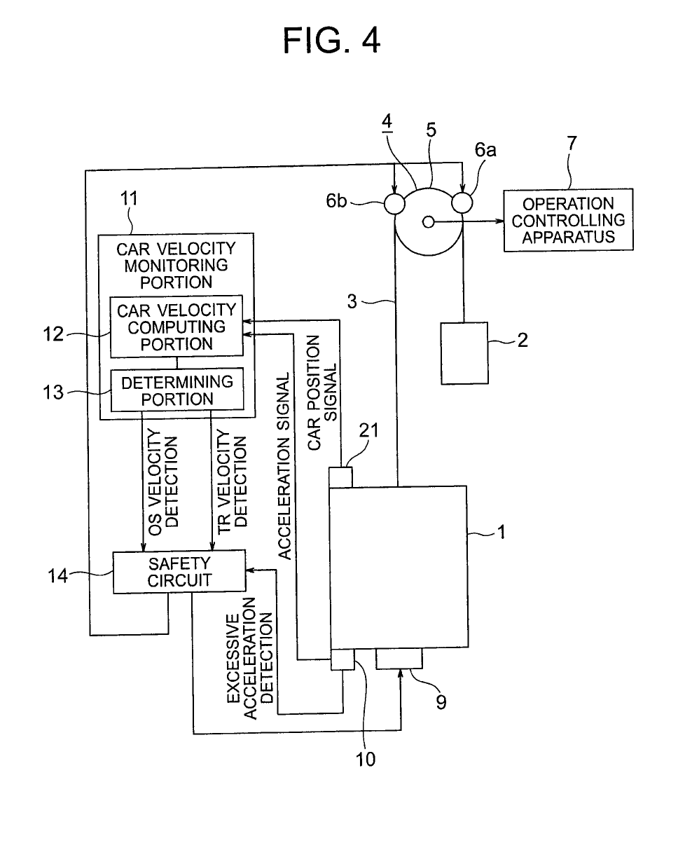

Next, FIG. 4 is a schematic configuration diagram that shows an elevator apparatus according to Embodiment 3 of the present invention partially in block form. In Embodiment 3, car position information that is obtained from a car position detector 21 that is disposed on at least one of the car 1 and the hoistway is used in a car velocity calculation in a car velocity computing portion 12, in addition to acceleration information that is obtained from an acceleration detector 10. Floor alignment sensors, releveling sensors, or terminal switches that are installed in elevator apparatuses conventionally, for example, can be used as the car position detector 21.

Specifically, a relationship between a signal from the car position detector 21 and car positions inside the hoistway is preprogrammed into the car velocity computing portion 12 during installation of the elevator apparatus, and a traveling velocity of the car 1 that is calculated from the acceleration signal is corrected based on a car position signal (absolute position information) that is obtained from the car position detector 21 while the car 1 is traveling.

Methods for correcting the traveling velocity include measuring the time taken to pass through two points inside the hoistway, finding the traveling velocity of the car 1 from distances between two points and times that are required to pass through them that are known in advance, and correcting the traveling velocity that is found from the acceleration signal in the car velocity computing portion 12.

Alternatively, the traveling velocity may be found from the acceleration signal, the car position found from that traveling velocity and compared with the car position that is detected by the car position detector 21, and the traveling velocity corrected based on the difference between the two. In addition, the configuration may be such that an abnormality detection signal is generated if a difference between a computational result from the acceleration signal and the position information from the position detector 21 becomes greater than a preset value. The rest of the configuration and operation are similar or identical to those of Embodiment 1 or 2.

In an elevator apparatus of this kind, because the traveling velocity of the car 1 is corrected using the signal from the car position detector 21, reliability of the car velocity monitoring portion 11 can be improved.

Moreover, in the above examples, an encoder 18 is shown as the signal generating portion, but the signal generating portion is not limited thereto.

In the above examples, an arm 16 that pivots in response to acceleration of the car 1 is shown as the displacing member, but the displacing member is not limited thereto, and may alternatively be displaced by sliding rectilinearly, for example.

In addition, a mechanism that increases (accelerates) and transmits displacement of the displacing member may be interposed between the displacing member and the signal generating portion.

Furthermore, in the above examples, a car velocity monitoring portion 11 that detects excessive velocities is shown instead of a conventional speed governor, but the car velocity monitoring portion may additionally have the function of an emergency terminal slowdown (ETS) apparatus (a terminal floor forced deceleration apparatus) that monitors the traveling velocity of the car 1 in a vicinity of a hoistway terminal floor and stops the car 1 forcibly, for example. In that case, the set values of the excessive velocities may be set so as to decrease gradually toward the termini of the hoistway. Alternatively, an ETS apparatus may be disposed separately from the car velocity monitoring portion 11 that is shown in Embodiment 1, and the signal from the acceleration detector 10 distributed and inputted into both the car velocity monitoring portion 11 and the ETS apparatus, and converted into a traveling velocity by each.

Furthermore, the overall layout of the elevator apparatus is not limited to the layout in FIG. 1. For example, the present invention can also be applied to elevator apparatuses that use two-to-one (2:1) roping methods, elevator apparatuses in which a hoisting machine 4 is installed in a lower portion of a hoistway, etc.

In addition, the present invention can be applied to any type of elevator apparatus, such as elevator apparatuses that have a machine room, machine-roomless elevators, linear motor elevators, hydraulic elevators, double-deck elevators, single-shaft multi-car elevators in which a plurality of cars are disposed inside a shared hoistway, etc.

1. An elevator apparatus comprising:
a car;
a braking apparatus that brakes traveling of the car;
an acceleration detector that is mounted to the car, and that generates an acceleration signal that corresponds to acceleration in a direction of travel of the car; and
a car velocity monitoring portion that finds a traveling velocity of the car from the acceleration signal, and that stops the car by means of the braking apparatus if the traveling velocity of the car reaches a preset excessive velocity,
wherein the acceleration detector includes:
an elastic body;
a displacing member that is connected to the elastic body, and that elastically deforms the elastic body while displacing in response to the acceleration of the car; and
a signal generating portion that detects displacement of the displacing member, and that generates a signal that corresponds to an amount of displacement of the displacing member as the acceleration signal, and
wherein the car velocity monitoring portion finds the traveling velocity of the car by integrating the acceleration signal from the acceleration detector.

2. (canceled)

3. The elevator apparatus according to claim 1, further comprising a descent safety switch that is actuated mechanically by the displacing member if acceleration in a direction of descent of the car reaches a preset threshold value,
the braking apparatus including a safety device that is mounted to the car, and
the car being made to perform an emergency stop using the safety device without referral to the car velocity monitoring portion when the descent safety switch is actuated.

4. The elevator apparatus according to claim 1, further comprising an ascent safety switch that is actuated mechanically by the displacing member if acceleration in a direction of ascent of the car reaches a preset threshold value,
the car being made to perform an emergency stop using the braking apparatus without referral to the car velocity monitoring portion when the ascent safety switch is actuated.

5. The elevator apparatus according to claim 1, further comprising a car position detector that detects a position of the car,
the car velocity monitoring portion correcting the traveling velocity of the car that is found from the acceleration signal based on a signal from the car position detector.

6. (canceled)
